(19) United States
(12) Patent Application Publication
(10) Pub. No.: US 2009/0050008 A1
(43) Pub. Date: Feb. 26, 2009

(54) PRINTING PRESS

(75) Inventor: Toshio Miwa, Hiroshima (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD., Tokyo (JP)

(21) Appl. No.: 12/279,147

(22) PCT Filed: Feb. 16, 2007
(86) PCT No.: PCT/JP2007/052870

§ 371 Date: Aug. 12, 2008

(30) Foreign Application Priority Data
Feb. 21, 2006 (JP) 2006-043806

(51) Int. Cl. B41F 35/00

(52) U.S. Cl. 101/424.1

(57) ABSTRACT

A printing press capable of expediting the drying of ink printed on a sheet and facilitating maintenance is provided. The printing press is characterized by including: an impression cylinder for transferring ink onto printing paper (P) during transport of the printing paper (P) there through; an transfer cylinder for transporting the printing paper (P) on which the ink has been transferred; a drying part for drying the ink transferred on the printing paper (P); and a support part for supporting the drying part so that it can rotate around a rotation axis extending parallel to the rotation axis of the impression cylinder, thereby bringing the drying part close to and away from the impression cylinder.

### RELATED APPLICATIONS

The present application is based on International Application Number PCT/JP2007/052870 filed Feb. 16, 2007, and claims priority from Japanese Application Number 2006-043806 filed Feb. 21, 2006, the disclosures of which are hereby incorporated by reference herein in their entirety.

### TECHNICAL FIELD

The present invention relates to printing presses, and in particular to sheet-fed printing presses for printing sheets.

### BACKGROUND ART

Conventionally, in a sheet-fed printing press, ink printed on a printed sheet has been dried overnight. The dried sheet has been sent to a subsequent process and subjected to cutting or the like.

However, in recent years, there has been demand to carry out cutting or the like after printing is done on a sheet, and the need for the provision of a drier for drying printed ink has been increased also in a sheet-fed printing press.

Therefore, in order to satisfy the above-described needs, a sheet-fed printing press equipped with a drier for drying ink has been proposed (see Patent Citation 1, for example).

Patent Citation 1: Japanese Unexamined Patent Application, Publication No. 2005-125739

### DISCLOSURE OF INVENTION

Patent Citation 1 mentioned above discloses a structure of a sheet-fed printing press including a drier having: an air guide part having a concave outline conforming to a cylinder; and a modular air blowing part.

It is described that the above-mentioned structure is capable of drying ink, which has been printed on a paper, with the use of the drier that utilizes hot air and infrared rays in combination. Hot air blown from the air blowing part flows into the air guide part, and the hot air is guided by the air guide part so as to be immediately in front of the cylinder. It is described that the hot air, blown out from the air blowing part, can be thus blown on a printed paper placed on the cylinder.

The above-mentioned drier is capable of slidingly moving the air blowing part in a direction of the rotation axis of the cylinder, and of rotating the air guide part around a rotation joint. It is described that, in doing so, the maintenance of the cylinder can be easily carried out.

However, in the drier of the above-mentioned sheet-fed printing press, a gap is created between the air blowing part and the air guide part. Therefore, there was a problem that a part of the hot air, blown from the air blowing part, flowed out through the gap, and was not used for the drying of ink. Since there exists a large distance between the air blowing part and the cylinder, the temperature of the hot air, blown out from the air blowing part, was reduced when the hot air was blown on a paper placed on the cylinder, thus causing a problem that it was difficult to expedite drying.

The air guide part was located between the air blowing part and the cylinder, thereby increasing the distance therebetween. Thus, there was a problem that the intensity of infrared rays emitted onto the cylinder from the air blowing part was reduced, thereby making it difficult to expedite the drying of ink.

It is conceivable that this problem can be solved by a method involving locating the air blowing part closer to the cylinder and removing the air guide part.

However, in such a structure, there is the problem that it is difficult to carry out the maintenance of the cylinder. That is, in the sheet-fed printing press, various mechanisms are located beside the cylinder. Therefore, a air blowing part which is located closer to the cylinder interferes with those mechanisms, thus making it impossible to slidingly move the air blowing part in the direction of the rotation axis of the cylinder. As a result, the cylinder is always covered by the air blowing part, thus causing a problem that it is difficult to carry out the maintenance of the cylinder. Since it is impossible to take out the air blowing part, there is the problem that it is also difficult to carry out the maintenance of the air blowing part.

The present invention has been made in view of the above-described problems, and its object is to provide a printing press capable of expediting the drying of ink printed on a sheet, and facilitating maintenance.

To achieve the above object, the present invention provides the following means.

The present invention provides a printing press including: an impression cylinder for allowing ink to be transferred on a printing paper during transport of the printing paper therethrough; an transfer cylinder for transporting the printing paper on which the ink has been transferred; a drying part for drying the ink transferred on the printing paper; and a support part for supporting the drying part so that it is rotatable around a rotation axis extending parallel to the rotation axis of the impression cylinder, thereby bringing the drying part close to and away from the impression cylinder.

According to the present invention, there is provided the support part for supporting the drying part so that it can be brought close to and away from the impression cylinder; thus, the drying of ink printed on the printing paper can be expedited, and in addition, the maintenance of the impression cylinder and the drying part can be facilitated.

The support part supports the drying part so that it is rotatable around the rotation axis extending parallel to the rotation axis of the impression cylinder; thus, when the drying part is brought to the impression cylinder, the drying part can be in close proximity to the impression cylinder. Therefore, the drying part can be brought in close proximity to the printing paper on which ink has been transferred, and the drying of the ink can be expedited.

On the other hand, when the drying part is removed from the impression cylinder, the drying part can be at a position far from the impression cylinder; therefore, for example, at such a position far from the impression cylinder, the drying part can be slidingly moved in the direction of the rotation axis of the impression cylinder. Thus, the maintenance of the drying part can be easily carried out. By slidingly moving the drying part, a space which communicates with the outside can be formed between the impression cylinder and the drying part, and the access to the impression cylinder can be facilitated.

The drying part is moved in a plane approximately perpendicular to the rotation axis of the impression cylinder; therefore, for example, even if various mechanisms are located beside the impression cylinder and/or the transfer cylinder, the drying part can be moved, and the maintenance of the drying part can be facilitated.

In the foregoing invention, there is preferably provided a pushing-up part for pushing up the support part in a direction in which it is taken away from the impression cylinder or the transfer cylinder.

By providing the pushing-up part in this way, the maintenance of the impression cylinder and the drying part can be facilitated.

The pushing-up part pushes up the support part in the direction in which it is taken away from the impression cylinder, thereby pushing up the drying part, supported by the support part, in the direction in which the drying part is taken away from the impression cylinder. For example, when a worker caries out the maintenance of the impression cylinder or the drying part, the support part and the drying part can be taken away from the impression cylinder by means of the pushing-up force of the pushing-up part. Thus, there is no need to use the force of a worker in taking the support part and the drying part away from the impression cylinder, and the maintenance of the impression cylinder or the drying part can be facilitated.

In the foregoing invention, the drying part is preferably supported on the support part so as to be rotatable in a direction in which the drying part is taken away from the impression cylinder.

In such an aspect, since the drying part on the support part is rotated in the direction in which it is taken away from the impression cylinder, the maintenance of the impression cylinder can be facilitated.

By rotating the drying part on the support part in the direction in which it is taken away from the impression cylinder, the drying part located close to the impression cylinder can be taken away from the impression cylinder, thereby forming a space communicating with the outside. The impression cylinder becomes accessible from the outside through this space, and the maintenance of the impression cylinder can be facilitated.

Since it is possible to carry out the maintenance of the impression cylinder without rotating its support part, the maintenance of the impression cylinder can be made easier than a method involving rotating its support part.

In the foregoing invention, the support part is preferably equipped with a movement support part which supports the drying part so that it is movable in the direction of the rotation axis of the impression cylinder.

Since the support part is equipped with a movement support part which supports the drying part so that it is movable in the direction of the rotation axis of the impression cylinder in this way, the maintenance of the drying part can be facilitated.

The drying part is moved in the direction of the rotation axis of the impression cylinder by means of the movement support part; therefore, the drying part can be taken further away from the impression cylinder, thereby making it possible to form a larger space communicating with the outside. Thus, when the maintenance of the impression cylinder is carried out, the drying part will not be an obstacle, and the maintenance can be further facilitated.

Since the drying part is moved in the direction of the rotation axis of the impression cylinder by means of the movement support part, the drying part can be moved to a larger space. Thus, the maintenance of the drying part can be further facilitated.

The printing press of the present invention includes the support part for supporting the drying part so that it can be brought close to and away from the impression cylinder, thus achieving the effects of allowing the drying of ink which is printed on printing paper to be expedited, and allowing the maintenance of the impression cylinder and the drying part to be facilitated.

### BRIEF DESCRIPTION OF DRAWINGS

FIG. 1 A cross-sectional view for describing a structure of a sheet-fed printing press according to a first embodiment of the present invention.

FIG. 2 A partial cross-sectional view for describing a structure of a printing unit shown in FIG. 1.

FIG. 3 A partial cross-sectional view for describing a situation in which a drying device and a support part shown in FIG. 2 are taken away from an impression cylinder.

FIG. 4 A diagram for describing another embodiment of the printing press shown in FIG. 1.

FIG. 5 A partial cross-sectional view for describing a structure of a support part in a printing press according to a variation of the first embodiment of the present invention.

FIG. 6 A partial cross-sectional view for describing a structure of a support part in a printing press according to a second embodiment of the present invention.

### EXPLANATION OF REFERENCE

1, 101, 201: printing press
17: impression cylinder
18: transfer cylinder
51: drying device (drying part)
53, 153, 253: support part
69: rail (movement support part)
71: spring part (pushing-up part)
P: sheet (printing paper)

### BEST MODE FOR CARRYING OUT THE INVENTION

### First Embodiment

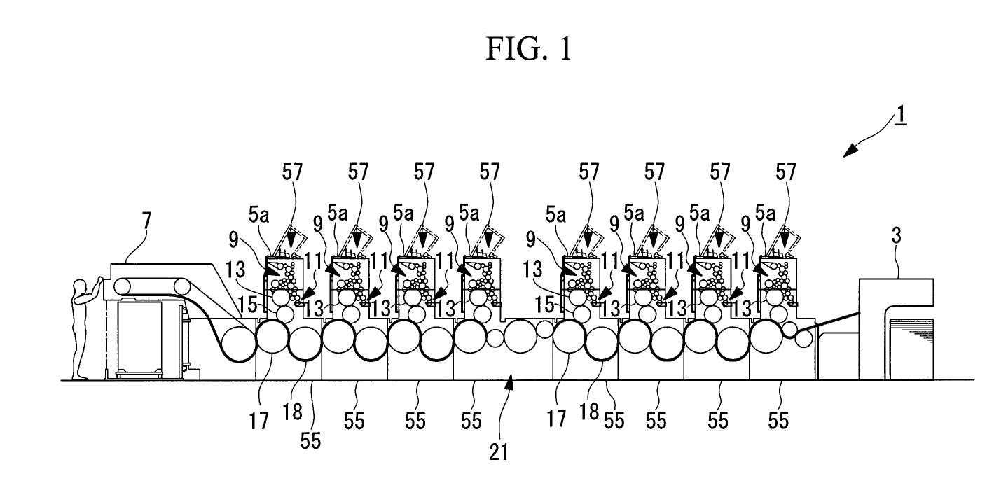

Hereinafter, a sheet-fed printing press according to a first embodiment of the present invention will be described with reference to FIGS. 1 to 4.

FIG. 1 is a cross-sectional view for describing a structure of a sheet-fed printing press according to the present embodiment.

The sheet-fed printing press (hereinafter, simply called a “printing press”) 1 in the present embodiment is a double-sided printing press for printing the front side and back side of a sheet (printing paper) P serving as a substrate. From the upstream side, from which the sheets P serving as substrates are fed, toward the downstream side, the printing press 1 includes: a feeder 3; a plurality of printing units 5a for printing the front side of each sheet; an inverting unit 21 for inverting each sheet; a plurality of printing units 5b for printing the back side of each sheet; and a paper ejecting device 7.

The feeder 3 serves as a device for feeding, one by one, stacked sheet substrates.

The paper ejecting device 7 serves as a device for collecting and stacking printed substrates. The paper ejecting device 7 is provided with an imaging device (not shown) for grasping how the substrate is printed.

The paper ejecting device 7 is provided with an ejected paper identification device (not shown) for making markings or the like on the printed sheets P. As the delivery identification device, for example, a tape inserter for putting tags on predetermined sheets P, and/or double delivery or the like for separating a predetermined number of sheets P into a different stack from the other sheets is used.

As shown in FIG. 1, a plurality of the printing units 5a, 5b are provided. In the present embodiment, description will be made on the supposition that the present invention is applied to the printing press 1, in which the front side of each sheet P is printed using the four printing units 5a, and then the back side of each sheet P is printed using the four printing units 5b.

The printing units 5a, 5b each include: an ink device 9 for supplying ink; a plate cylinder 13 located facing the ink device 9; a blanket cylinder 15 located facing the plate cylinder 13; an impression cylinder 17 located facing the blanket cylinder 15; and an transfer cylinder 18 located between the impression cylinders 17 of the respective printing units 5a, 5b.

As shown in FIG. 1, the printing units 5a, 5b each include: the ink device 9 for supplying ink; a dampening device 11 for supplying dampening solution; the plate cylinder 13 located facing these ink devices 9 and dampening device 11; the blanket cylinder 15 located facing the plate cylinder 13; the impression cylinder 17 located facing the blanket cylinder 15; and the transfer cylinder 18 located between the impression cylinders 17 of the respective printing units 5a, 5b.

Each ink device 9 includes a plurality of ink rollers, and is formed so as to sequentially supply ink from an ink reservoir, in which ink is stored, toward the plate cylinder 13. Each ink device 9 includes four ink-applying rollers that come into contact with the plate cylinder 13 during printing.

Each dampening device 11 includes a plurality of rollers, and is formed so as to supply dampening solution, stored in a solution vessel, toward the plate cylinder 13. Each dampening device 11 includes a single dampening roller that comes into contact with the plate cylinder during printing.

Each plate cylinder 13 is formed into a cylindrical shape, around the periphery of which a printing plate, having a printing image formed thereon, is wound. The printing plate is formed and changed for each image to be printed. Each plate cylinder 13 is in a state where a part of its periphery covering a certain angle is cut out in the axial direction, and the resulting gap is provided with plate clamping devices (not shown) for holding and fixing a plate head and a plate bottom which are upstream and downstream, respectively, of the printing plate.

A blanket made of rubber or the like is wound around the periphery of each blanket cylinder 15. Each blanket cylinder 15 is in a state where a part of its periphery covering a certain angle is cut out in the axial direction, and the resulting gap is provided with a rubber clamping device (not shown) for holding and fixing the upstream end and the downstream end of the rubber.

Each blanket cylinder 15 is formed so that it can be taken away from the plate cylinder 13 (i.e., the cylinders can be disconnected) in a non-printing period during which printing is not performed.

Each impression cylinder 17 is located facing the blanket cylinder 15, and is formed into a cylindrical shape. During printing, each impression cylinder 17 comes into contact with the blanket cylinder 15, and presses the substrate supplied between the impression cylinder 17 and the blanket cylinder 15 with a desired pressure.

Each transfer cylinder 18 is provided between the impression cylinders 17 of the respective printing units 5, and is formed into a cylindrical shape. Each transfer cylinder 18 sends the sheets P, serving as substrates, from upstream of impression cylinder 17 to downstream of impression cylinder 17.

The above-described plate cylinders 13, blanket cylinders 15, impression cylinders 17, and transfer cylinders 18 are rotated by a single main motor (not shown) provided in the printing press 1. In other words, a torque from the main motor is transmitted to the impression cylinders 17, transfer cylinders 18, blanket cylinders 15 and the plate cylinders 13 via gears.

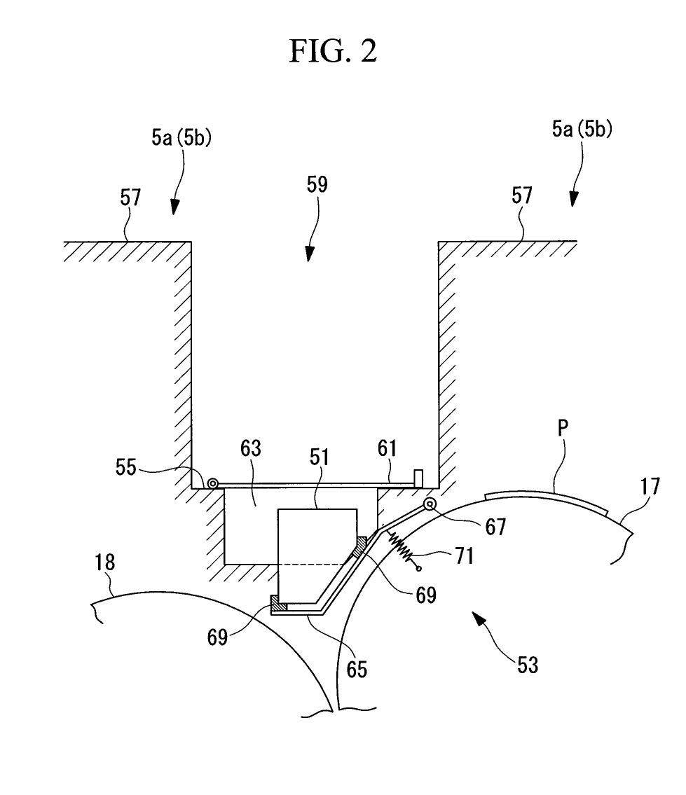

FIG. 2 is a partial cross-sectional view for describing a structure of each printing unit shown in FIG. 1.

As shown in FIG. 2, the printing units 5a, 5b each further include: a drying device (drying part) 51 for drying ink printed on the sheet P; and a support part 53 for supporting the drying device 51 so that it can be brought close to and away from the impression cylinder 17.

As shown in FIG. 1, frames 55 serving as casings for the printing units 5a, 5b are each formed with a convex part 57 in which the ink device 9, the dampening device 11 and the like are located. As shown in FIG. 2, a space 59 through which a worker can pass is formed between the convex parts 57, 57 in the adjacent printing units 5a, 5a, or between the convex parts 57, 57 in the adjacent printing units 5b, 5b. At a portion of each frame 55 located at a bottom face of the space 59, an inter-unit step 61 serving as a footboard for a worker is located, and a concave cutout part 63 is formed under the inter-unit step 61 (at a lower part of FIG. 2). In other words, the inter-unit step 61 is located so as to cover the cutout part 63.

The cutout part 63 may be provided with wiring through which electric power is supplied to the drying device 51, or may be used as a ventilation duct.

The inter-unit step 61 is fixed so as to be rotatable toward the downstream side printing unit 5a or printing unit 5b with respect to the direction in which the sheet P flows.

The drying device 51 serves to dry ink printed on the sheet P, and is a UV irradiation type drying device for irradiating ultraviolet rays (hereinafter, expressed as UV), for example. It should be noted that the drying device 51 is not particularly limited, the above-mentioned UV irradiation type drying device, a drying device for irradiating infrared rays, or a drying device for blowing hot air being usable in accordance with the drying properties of ink.

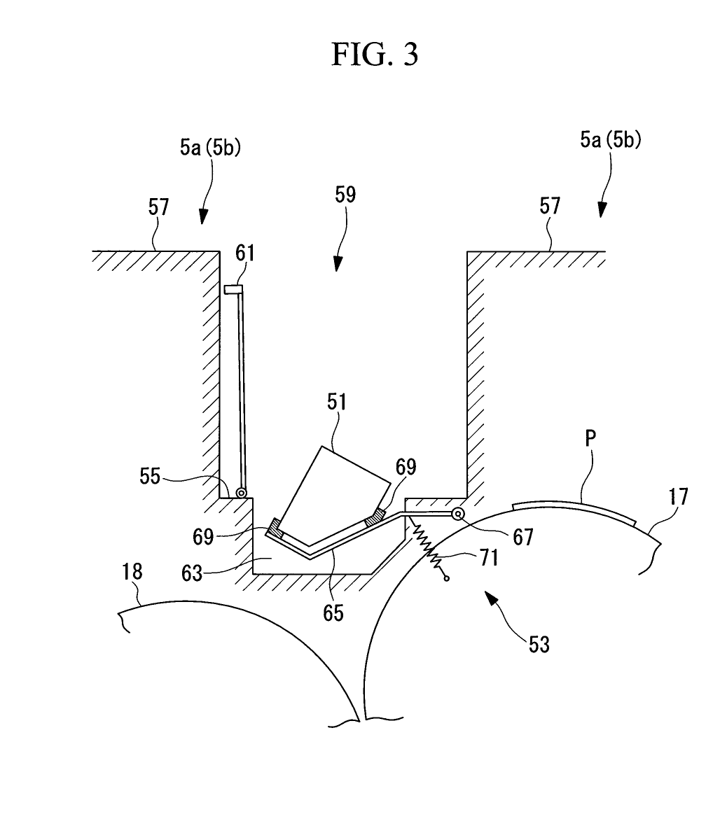

FIG. 3 is a partial cross-sectional view for describing a situation in which the drying device 51 and the support part 53 in FIG. 2 are separated from the impression cylinder 17.

The support part 53 serves to support the drying device 51, and to rotate around a rotation shaft 67 so as to bring the drying device 51 close to and away from the impression cylinder 17.

Specifically, as shown in FIG. 2, when the support part 53 rotates the drying device 51 downward, this allows the drying device 51 to be brought in close proximity to the impression cylinder 17.

On the other hand, as shown in FIG. 3, when the drying device 51 is rotated upward, the drying device 51 can be taken away so as to be located at a position where it can be slidingly moved in the direction of the rotation axis of the impression cylinder 17. By slidingly moving the drying device 51, the impression cylinder 17 becomes accessible from the space 59.

As shown in FIG. 2, the support part 53 includes: a pair of rotation members 65; the rotation shaft 67 provided at one end of the rotation members 65; two rails (movement support part) 69 provided extending across a pair of the rotation members 65; and a spring part (pushing-up part) 71 for urging the support part 53 in the direction in which it separates from the impression cylinder 17.

The rotation members 65 each consist of a rod member bent so as to be roughly L-shaped, and are located at an operating frame (for example, a frame located closer to the viewer with respect to the plane of FIG. 2) and at a power drive frame (for example, a frame located away from the viewer with respect to the plane of FIG. 2) in the printing units 5a and 5b. The rotation members 65 are arranged approximately in parallel with each other, and the rotation member 65 located at the operating side of the printing press 1 (for example, one located closer to the viewer with respect to the plane of FIG. 2), is formed (as a lever) so that a worker can hold it. A worker can hold the rotation member 65, located at the operating side, and can rotate it so that the support part 53 and the drying device 51 are brought close to and away from the impression cylinder 17.

The rotation shaft 67 serves to rotatably support the rotation members 65 with respect to the frames 55, and is located above the impression cylinder 17 and close to the bottom face of the space 59. The rotation shaft 67 has a rotation axis extending parallel to the rotation axis of the impression cylinder 17.

The rails 69 serve to support the drying device 51 so that it is movable in the direction of the rotation axis of the impression cylinder 17. The two rails 69 are arranged side by side so as to extend in the direction of the rotation axis of the impression cylinder 17, and are located so as to connect with a pair of the rotation members 65.

The spring part 71 is a member that is fixed, at one end thereof, to the rotation members 65, and is fixed, at the other end thereof, to the frame 55. The spring part 71 is compressed in a state where the drying device 51 is located close to the impression cylinder 17, and urges the drying device 51 and the support part 53 in the direction in which they separate from the impression cylinder 17. It should be noted that the spring part 71 may be a known spring such as a coil spring. The means for urging the support part 53 as described above is not particularly limited since the spring part 71 may be used, or other urging means may be used.

Next, the functions of the printing press 1 structured as described above will be described.

First, as shown in FIG. 1, the sheets P are sent out one by one from the feeder 3. The sheet P has its front side printed when passing through the first four printing units 5a. Thereafter, the sheet P is inverted by the inverting unit 21.

The sheet P which has been inverted has its back side printed when passing through the four printing units 5b located at the downstream side. The sheet P, which has its both sides printed in this manner, is sent to the paper ejecting device 7.

Next, the functions of the drying device, which are features of the present embodiment, will be described.

The sheet, on which predetermined ink has been printed in the printing units 5a, 5b is transported to the transfer cylinder 18 by the impression cylinder 17 as shown in FIG. 2. A region of the sheet on which ink has been printed facing the drying device 51 is irradiated with ultraviolet rays emitted from the drying device 51, thereby drying the ink on the sheet. The sheet, the ink of which has been dried, is transported from the impression cylinder 17 to the transfer cylinder 18, and is then transported from the transfer cylinder 18 to the impression cylinder 17 of the next printing units 5a, 5b.

By repeating the above-described steps, both the printing and drying steps are carried out in each of the printing units 5a, 5b.

Next, a maintenance method for the impression cylinder 17 or the drying device 51, which is a feature of the present embodiment, will be described.

When the maintenance of the impression cylinder 17 or the drying device 51 is to be carried out, first, the inter-unit step 61 is rotated upward, exposing the drying device 51 located within the cutout part 63 to the outside, as shown in FIG. 3. Then, the rotation member 65 is grasped and rotated in the direction in which the drying device 51 and the support part 53 are separated from the impression cylinder 17. At this time, since the urging force of the spring part 71 is exerted, the force for rotating the drying device 51 and the support part 53 is small. Alternatively, the drying device 51 and the support part 53 are rotated in the direction in which they separate from the impression cylinder 17 by the urging force of the spring part 71 alone.

Upon rotation of the drying device 51 to the cutout part 63, the drying device 51 is then slidingly moved along the rails 69, parallel to the rotational center axis of the impression cylinder 17. For example, the drying device 51 is slidingly moved to the operating side of the printing units 5a, 5b (the near side of FIG. 3).

Upon movement of the drying device 51, there occurs a situation in which only the support part 53 is located between the space 59 and the impression cylinder 17. Since the support part 53 is constituted by a combination of the rotation members 65 and the rails 69, a space from which the impression cylinder 17 is accessible is formed between the space 59 and the impression cylinder 17. A worker carries out the maintenance of the impression cylinder 17 through this space.

On the other hand, the maintenance of the drying device 51 is carried out in a situation where it has been slidingly moved along the rails 69.

In the above-described structure, there is provided the support part 53 for supporting the drying device 51 so that it can be brought close to and away from the impression cylinder 17, thus making it possible to expedite the drying of ink printed on sheets, and to facilitate the maintenance of the impression cylinder 17 and the drying device 51.

The support part 53 supports the drying device 51 so that it is rotatable around the rotation axis extending parallel to the rotation axis of the impression cylinder 17; therefore, when the drying device 51 is brought to the impression cylinder 17, the drying device 51 can be in close proximity to the impression cylinder 17. Thus, the drying device 51 can be brought in close proximity to the sheet on which ink has been transferred, and the drying of the ink can be facilitated.

On the other hand, when the drying device 51 is taken away from the impression cylinder 17, the drying device 51 can be moved to a position far from the impression cylinder 17; therefore, for example, at a position far from the impression cylinder 17, the drying device 51 can be slidingly moved in the direction of the rotation axis of the impression cylinder 17. Thus, the maintenance of the drying device 51 can be easily carried out. By slidingly moving the drying device 51, a space communicating with the outside can be formed between the impression cylinder 17 and the drying device 51, and the access to the impression cylinder 17 can be facilitated.

The drying device 51 is moved in a plane approximately perpendicular to the rotation axis of the impression cylinder 17; therefore, for example, even if various mechanisms are located beside the impression cylinder 17 and/or the transfer cylinder 18, the drying device 51 can be slidingly moved, and the maintenance of the drying device 51 can be facilitated.

By providing the spring part 71, the maintenance of the impression cylinder 17 and the drying device 51 can be facilitated.

The spring part 71 pushes up the support part 53 in the direction in which it separates from the impression cylinder 17, thereby pushing up the drying device 51 supported by the support part 53 in the direction in which the drying device 51 separates from the impression cylinder 17. For example, when a worker carries out the maintenance of the impression cylinder 17 or the drying device 51, the support part 53 and the drying device 51 can be removed from the impression cylinder 17 by means of the pushing-up force of the spring part 71. Thus, there is no need to use the force of a worker in taking the support part 53 and the drying device 51 away from the impression cylinder 17, and the maintenance of the impression cylinder 17 or the drying device 51 can be facilitated.

Since the support part 53 includes the rails 69 that support the drying device 51 so that it is slidingly movable in the direction of the rotation axis of the impression cylinder 17, the maintenance of the drying device 51 can be facilitated.

By means of the rails 69, the drying device 51 is moved in the direction of the rotation axis of the impression cylinder 17; therefore, the drying device 51 can be taken further away from the impression cylinder 17, thereby making it possible to form a larger space communicating with the outside. Thus, when the maintenance of the impression cylinder 17 is carried out, the drying device 51 will not be an obstacle, and the maintenance can be further facilitated.

Since the drying device 51 can be moved in the direction of the rotation axis of the impression cylinder 17 by means of the rails 69, the drying device 51 can be moved to a larger space. Thus, the maintenance of the drying device 51 can be further facilitated.

Since the printing units 5a, 5b each include the drying device 51, a drying unit for drying ink does not have to be located upstream of the inverting unit 21 in the printing press 1. At the same time, a paper ejecting device 7 such as a long delivery apparatus including a plurality of drying devices for drying ink does not have to be used.

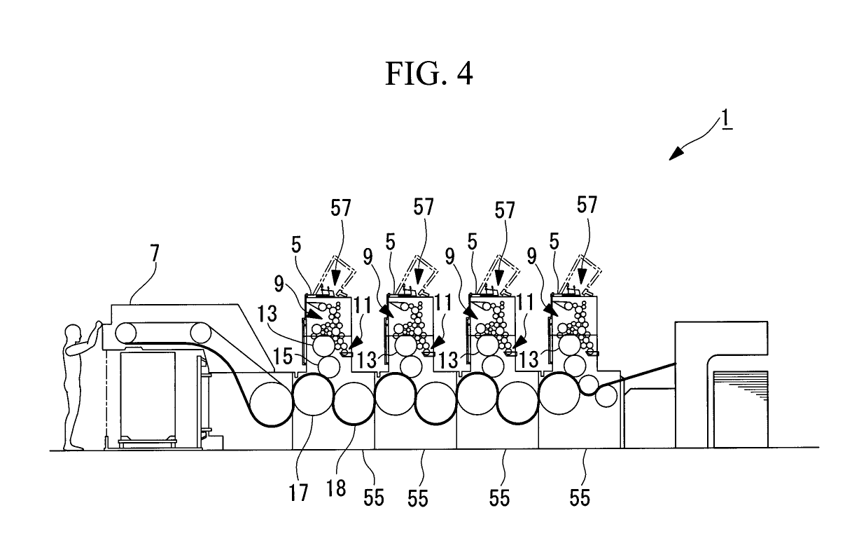

FIG. 4 is a diagram for describing another embodiment of the printing press shown in FIG. 1.

It should be noted that the printing press 1 is not particularly limited to a double-sided sheet-fed printing press capable of printing the front side and back side of each sheet as described above, and may be a sheet-fed printing press capable of printing only the front side of each sheet as shown in FIG. 4.

### Variation of First Embodiment

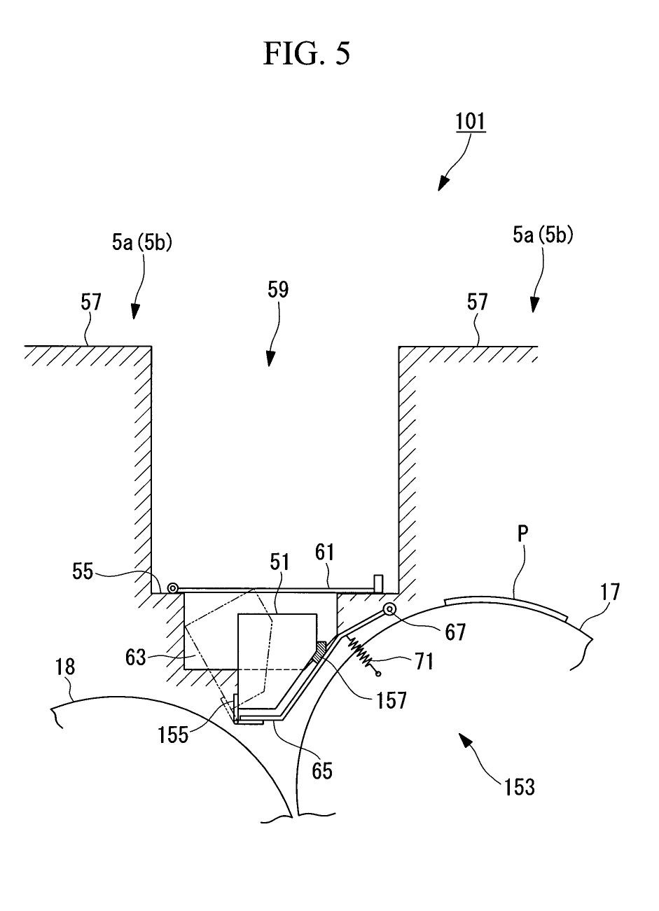

Next, a variation of the first embodiment of the present invention will be described with reference to FIG. 5.

A basic structure of a printing press according to the present variation is similar to that of the printing press according to the first embodiment, but the structure of a support part differs from the first embodiment. Hence, in the present embodiment, only the surroundings of the support part will be described with reference to FIG. 5, and the description of the other constituent elements and the like will be omitted.

FIG. 5 is a partial cross-sectional view for describing the structure of the support part in the printing press according to the present variation.

It should be noted that the same constituent elements as those of the first embodiment are identified by the same reference characters, and the description thereof will be omitted.

As shown in FIG. 5, printing units 5a, 5b of the printing press 101 each include: a drying device 51 for drying ink printed on a sheet P; and a support part 153 for supporting the drying device 51 so that it can be brought close to and away from an impression cylinder 17.

As shown in FIG. [[2]]5, the support part 153 serves to support the drying device 51, and to rotate around a rotation shaft 67 so as to bring the drying device 51 close to and away from the impression cylinder 17.

The support part 153 includes: a pair of rotation members 65; the rotation shaft 67 provided at one end of the rotation members 65; a spring part 71 for urging the support part [[53]]153 in a direction in which it separates from the impression cylinder 17; a rotation support part 155 for rotatably supporting the drying device 51 on the rotation members 65; and a stopper 157 for regulating the rotation of the drying device 51 around the rotation support part 155.

The rotation support part 155 is located at one end of the rotation members 65 (at the left side end in FIG. 5), and connects the rotation members 65 with the drying device 51 so that the drying device 51 can rotate around one end of the rotation members 65.

The stopper 157 is provided at the rotation members 65, and serves to regulate the rotation range of the drying device 51 when the drying device 51 is rotated toward the impression cylinder 17. Specifically, the stopper serves to regulate the position of the drying device 51 so that the surface of the drying device 51 providing UV irradiation faces the impression cylinder 17.

Next, the functions of the printing press 101 structured as described above, and the functions of the drying device 51 will be described.

The functions of the printing press 101 and drying device 51 according to the present variation are similar to those of the printing press and drying device according to the first embodiment, and therefore, the description thereof will be omitted.

Next, a maintenance method for the impression cylinder 17 or the drying device 51, which is a feature of the present variation, will be described.

When the maintenance of the impression cylinder 17 is carried out in the printing press 101 according to the present variation, similarly to the first embodiment, an inter-unit step 61 is rotated upward, exposing the drying device 51 located within a cutout part 63 to the outside. Then, the drying device 51 is rotated by means of the rotation support part 155 as indicated by the chain double-dashed line in FIG. 5.

Upon rotation of the drying device 51, a space from which the impression cylinder 17 is accessible is formed between the cutout part 63 and the impression cylinder 17. A worker carries out the maintenance of the impression cylinder 17 through this space.

It should be noted that the method of carrying out the maintenance of the impression cylinder 17 and the drying device 51 by rotating the entire support part 153 in the direction in which it separated from the impression cylinder 17 is similar to that of the first embodiment, and therefore, the description thereof will be omitted.

In the above-described structure, the drying device 51 is rotated above the support part 153 in the direction in which it is separated from the impression cylinder 17, and therefore, the maintenance of the impression cylinder 17 can be facilitated.

By connecting the drying device 51 with the rotation members 65 using the rotation support part 155, the drying device 51 can be rotated in the direction in which it is separated from the impression cylinder 17 over the support part 153.

By rotating the drying device 51 in the direction in which it is separated from the impression cylinder 17, the drying device 51 located close to the impression cylinder 17 can be taken away from the impression cylinder 17, thereby making it possible to form a space communicated with the outside. The impression cylinder 17 becomes accessible from the outside through this space, and the maintenance of the impression cylinder 17 can be facilitated.

Since it is possible to carry out the maintenance of the impression cylinder 17 without rotating the entire support part 153, the maintenance of the impression cylinder 17 can be facilitated as compared with a method of rotating the entire support part 153.

### Second Embodiment

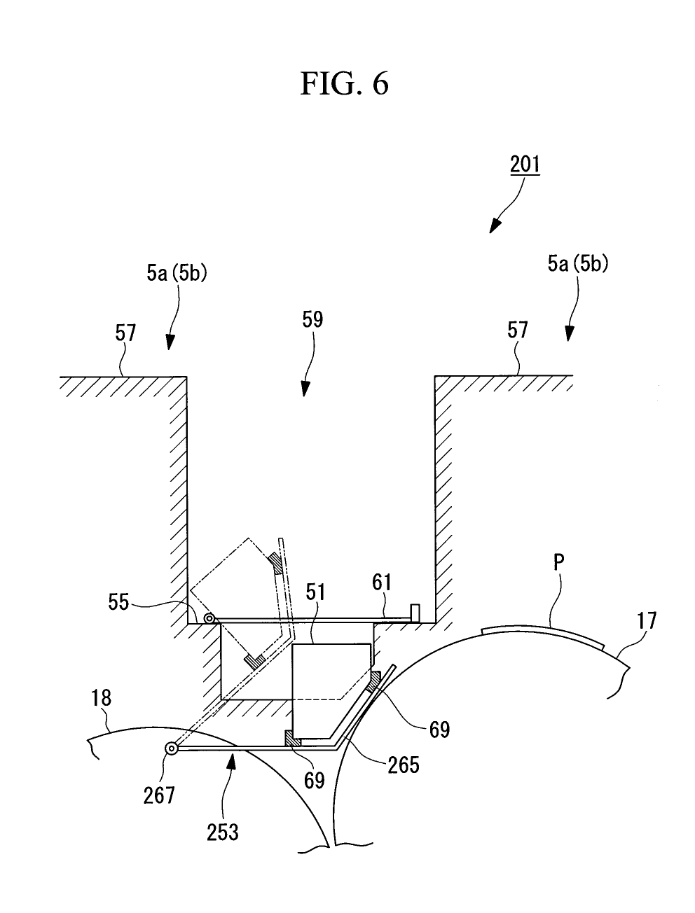

Next, a second embodiment of the present invention will be described with reference to FIG. 6.

The basic structure of a printing press according to the present embodiment is similar to that of the printing press according to the first embodiment, but the structure of a support part differs from the first embodiment. Hence, in the present embodiment, only the surroundings of the support part will be described with reference to FIG. 6, and the description of the other constituent elements and the like will be omitted.

FIG. 6 is a partial cross-sectional view for describing the structure of the support part in the printing press according to the present embodiment.

It should be noted that the same constituent elements as those of the first embodiment are identified by the same reference characters, and the description thereof will be omitted.

As shown in FIG. 6, printing units 5a, 5b of the printing press 201 each include: a drying device 51 for drying ink printed on a sheet P; and a support part 253 for supporting the drying device 51 so that it can be brought close to and away from an impression cylinder 17.

The support part 253 serves to support the drying device 51, and to rotate around a rotation shaft 267 so as to bring the drying device [[251]]51 close to and away from the impression cylinder 17.

Specifically, as indicated by the solid line in FIG. 6, when the drying device 51 is rotated downward, the support part 253 allows the drying device 51 to be brought in close proximity to the impression cylinder 17.

On the other hand, when the drying device 51 is rotated upward, as indicated by the chain double-dashed line in FIG. 6, the drying device 51 can be taken away so as to be located at a position where it can be slidingly moved in the direction of the rotation axis of the impression cylinder 17. By slidingly moving the drying device 51, the impression cylinder 17 becomes accessible from a cutout part 63.

As shown in FIG. 6, the support part 253 includes: a pair of rotation members 265; the rotation shaft 267 provided at one end of the rotation members 265; and two rails 69 provided across the pair of the rotation members 265.

The rotation members 265 each consist of a rod member bent so as to be roughly L-shaped, and are located at an operating-side frame (for example, a frame located closer to the view with respect to the plane of FIG. 6) and at a driven-side frame (for example, a frame located further from the viewer with respect to the plane of FIG. 6) in the printing units 5a, 5b. The rotation members 265 are arranged approximately in parallel with each other, and the rotation member 265, located at the operating side in the printing press 201 (for example, one located closer to the viewer with respect to the plane of FIG. 6), is formed (as a lever) so that a worker can hold it. A worker can hold the rotation member 265 located at the operating side and can rotate it so that the support part 253 and the drying device 51 are brought close to and away from the impression cylinder 17.

The rotation shaft 267 serves to rotatably support the rotation members 265 with respect to a frame 55, and is located close to an transfer cylinder 18. The rotation shaft 267 has a rotation axis extending parallel to the rotation axis of the transfer cylinder 18.

Next, the functions of the printing press 201 structured as described above, and the functions of the drying device 51 will be described.

The functions of the printing press 201 and drying device 51 according to the present embodiment are similar to those of the printing press and drying device according to the first embodiment, and therefore, the description thereof will be omitted.

Next, a maintenance method for the impression cylinder 17 or the drying device 51, which is a feature of the present embodiment, will be described.

When the maintenance of the impression cylinder 17 or the drying device 51 is carried out, first, an inter-unit step 61 is rotated upward, exposing the drying device 51 located within the cutout part 63 to the outside, as shown in FIG. 6. Then, the rotation member 265 is grasped and rotated in the direction in which the drying device 51 and the support part 253 are separated from the impression cylinder 17 as indicated by the chain double-dashed line in FIG. 6.

Upon rotation of the drying device 51 to the cutout part 63, the drying device 51 is then slidingly moved along the rails 69, parallel to the rotational center axis of the transfer cylinder 18. For example, the drying device 51 is slidingly moved to the operating side of the printing units 5a, 5b (toward the viewer of FIG. 6).

Upon movement of the drying device 51, a space from which the impression cylinder 17 is accessible is formed between the cutout part 63 and the impression cylinder 17. A worker carries out the maintenance of the impression cylinder 17 through this space.

On the other hand, the maintenance of the drying device is carried out in a situation where it has been slidingly moved along the rails 69.

1. A printing press comprising:
an impression cylinder for transferring ink onto printing paper during transport of the printing paper therethrough;
an transfer cylinder for transporting the printing paper on which the ink has been transferred;
a drying part for drying the ink transferred on the printing paper; and
a support part for supporting the drying part so that it is rotatable around a rotation axis extending parallel to the rotation axis of the impression cylinder, thereby bringing the drying part close to and away from the impression cylinder.

2. The printing press according to claim 1, comprising a pushing-up part for pushing up the support part in a direction in which it is separated from the impression cylinder or the transfer cylinder.

3. The printing press according to claim 1, wherein the drying part is supported so as to be rotatable in a direction in which the drying part is separated from the impression cylinder over the support part.

4. The printing press according to claim 1, wherein the support part comprises a movement support part for supporting the drying device so that it is movable in the direction of the rotation axis of the impression cylinder.
